(19) United States
(12) Patent Application Publication
(10) Pub. No.: US 2026/0252063 A1
(43) Pub. Date: Aug. 27, 2026

(54) INFORMATION PROVISION APPARATUS, INFORMATION PROVISION METHOD, AND INFORMATION PROVISION PROGRAM

(71) Applicant: Yokogawa Electric Corporation, Tokyo (JP)

(72) Inventor: Ryoichi HIMONO, Tokyo (JP)

(21) Appl. No.: 19/160,138

(22) PCT Filed: Feb. 28, 2024
(86) PCT No.: PCT/JP2024/007191

§ 371 Date: Aug. 27, 2025

(30) Foreign Application Priority Data
Mar. 6, 2023 (JP) 2023-034040

(51) Int. Cl. G05B 19/418; G06Q 10/0639; G06Q 50/04; G06T 11/26

(52) U.S. Cl. CPC G05B 19/41875; G06Q 10/06395; G06Q 50/04; G06T 11/26; G05B 2219/32187; G05B 2219/32194

(57) ABSTRACT

An information provision apparatus includes a collector and an evaluator. The collector collects management parameters and quality of manufactured lots. The evaluator evaluates quality of a lot to be evaluated that is predicted from management parameters of the lot to be evaluated based on the management parameters and the quality of the manufactured lots.

### TECHNICAL FIELD

The present invention relates to an information provision apparatus, an information provision method, and an information provision program.

### BACKGROUND ART

In many industries, it is required to stably realize target PQCD (Productivity, Quality, Cost, and Delivery (time of manufacturing)) and produce products. Techniques particularly for stabilizing the quality of products have been proposed.

For example, a method of previously determining parameters serving as a key (management parameters) and management ranges that the values of the management parameters should take in order to stably manufacture products that meet target quality features is known. In manufacturing steps, the management ranges of the management parameters are followed. A QM matrix is sometimes used as a method of managing the management parameters and the management ranges.

A method that ensures the quality of products by quality examination is also known. For example, quality examination on manufactured products is performed in order not to ship defective products to the market. Only products accepted according to the quality examination results are then shipped.

### CITATION LIST

### Patent Literature

PTL 1: Japanese Laid-open Patent Publication No. 2022-55231

### SUMMARY OF INVENTION

### Technical Problem

As described above, a technique for achieving the target (quality target) of Q (quality) of PQCD has been proposed. The conventional technique however has a problem in that it is difficult to achieve the quality target stably.

For example, when the 4Ms (the material features, facility state, man operations, and step state) that relate to manufacturing vary widely, even if operations are performed following the management ranges of the management parameters, defective products are produced in some cases.

Furthermore, there are increasing cases where requirements from users who receive products become more restrict and the quality level to be achieved gets higher and as a result products that pass quality examinations are treated as defective products by the users and the quality is not ensured by only quality examinations in some cases.

According to an aspect, there is an objective to stably achieve a quality target.

### Solution to Problem

According to one aspect of embodiments, an information provision apparatus includes: a collector that collects management parameters and quality of manufactured lots; and an evaluator that evaluates quality of a lot to be evaluated that is predicted from management parameters of the lot to be evaluated based on the management parameters and the quality of the manufactured lots.

According to one aspect of embodiments, an information provision method that is executed by a computer, the method includes: collecting management parameters and quality of manufactured lots; and evaluating quality of a lot to be evaluated that is predicted from management parameters of the lot to be evaluated based on the management parameters and the quality of the manufactured lots.

According to one aspect of embodiments, an information provision program causes a computer to execute a process comprising: collecting management parameters and quality of manufactured lots; and evaluating quality of a lot to be evaluated that is predicted from management parameters of the lot to be evaluated based on the management parameters and the quality of the manufactured lots.

### ADVANTAGEOUS EFFECTS OF INVENTION

According to an embodiment, it is possible to stably achieve a quality target.

### BRIEF DESCRIPTION OF DRAWINGS

FIG. 1 is a diagram illustrating an example of a configuration of an information provision apparatus according to a first embodiment.

FIG. 2 is a diagram illustrating an example of aggregated data.

FIG. 3 is a diagram illustrating an example of a screen.

FIG. 4 is a diagram illustrating an example of a screen.

FIG. 5 is a flowchart illustrating a flow of a process performed by the information provision apparatus according to the first embodiment.

FIG. 6 is a diagram illustrating an example of a hardware configuration.

### DESCRIPTION OF EMBODIMENTS

An embodiment of an information provision apparatus, an information provision method, and an information provision program will be described in detail below with reference to the drawings. The embodiment described herein does not limit the invention of the present application. The same elements are denoted with the same reference numerals and redundant description will be omitted as appropriate. Each embodiment can be combined as appropriate within a range without inconsistency.

The information provision apparatus of the embodiment provides information on manufacturing of products in a facility, such as a plant. As for the products, an operator operates a manufacturing facility and accordingly the products are manufactured. The operator is able to set management parameters. The management parameters are parameters for determining an amount of operation in the manufacturing facility, an amount of input of material, a time of processing, etc. The products are manufactured on a lot basis. The operator sets the management parameters per lot.

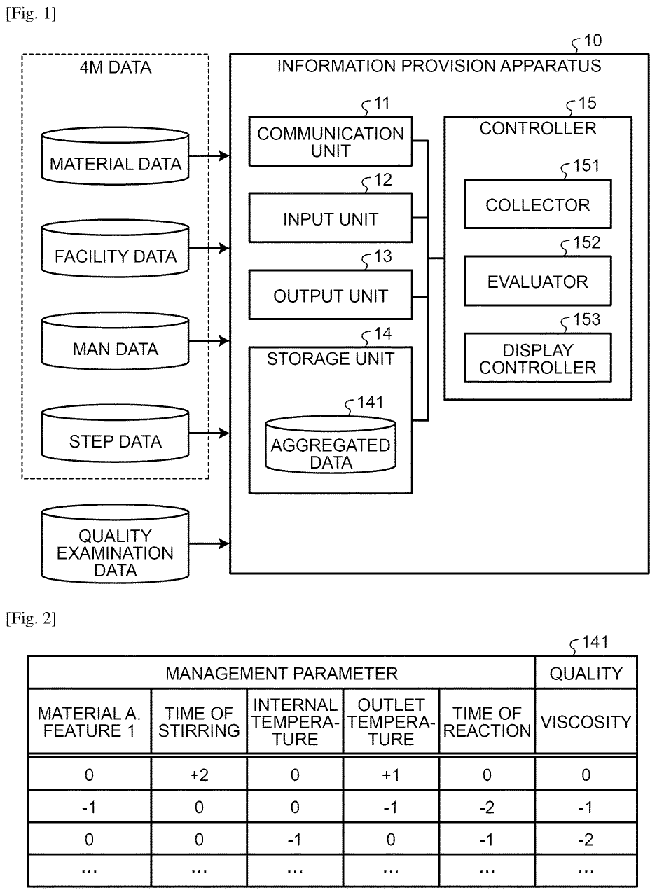

Using FIG. 1, a configuration of an information provision apparatus 10 will be described. FIG. 1 is a diagram illustrating an example of the configuration of the information provision apparatus according to a first embodiment. As illustrated in FIG. 1, the information provision apparatus 10 includes a communication unit 11, an input unit 12, an output unit 13, a storage unit 14, and a controller 15.

The communication unit 11 communicates data to other devices. The input unit 12 receives an input of data. The input unit 12 may be an interface that is connected to an input device, such as a keyboard and a mouse. The output unit 13 outputs data. The output unit 13 may be an interface that is connected to an output device, such as a display and a speaker.

The storage unit 14 store various types of data and various types of programs that the controller 15 executes. For example, the storage unit 14 is a storage device, such as a memory and a hard disk. The storage unit 14 stores various types of data generated in processes that the information provision apparatus 10 executes, such as data that is obtained by the controller 15 in a process of executing various types of processes and process results obtained by executing the various types of processes. The storage unit 14 stores aggregated data 141.

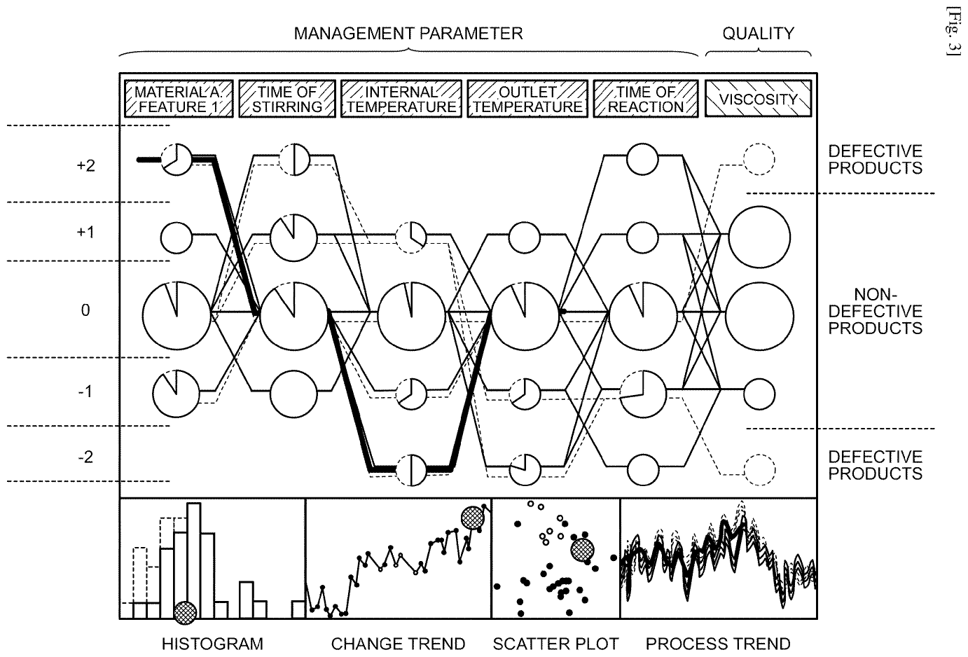

The aggregated data 141 is data obtained by aggregating management parameters and quality of manufactured lots. FIG. 2 is a diagram illustrating an example of the aggregated data.

Each record (row) of the aggregated data 141 illustrated in FIG. 2 corresponds to a manufactured lot. Each item (column) of the aggregated data 141 corresponds to the management parameters or quality. The management parameter includes “Material A. Feature 1”, “Time of Stirring”, “Internal Temperature”, “Outlet Temperature”, and “Time of Reaction”. The quality is represented by “Viscosity”.

Each cell of the aggregated data 141 is a discrete value representing a degree of variation in the management parameter or quality. A degree of variation of “+X” means that the management parameter or quality is discrete in X stages on an upper side (the side on which the value increases). A degree of variation of “−X” means that the management parameter or quality is discrete in X stages on a lower side (the side on which the value decreases). A degree of variation of “0” means that the management parameter or quality is within a given range.

The controller 15 is a processor that is in charge of the whole information provision apparatus 10. The controller 15 is realized using, for example, a processor, or the like. The controller 15 includes a collector 151, an evaluator 152, and a display controller 153.

The collector 151 collects management parameters and quality of manufactured lots and a lot to be evaluated. The same products are manufactured in the manufactured lots and the lot to be evaluated. The collector 151 collects management parameters and quality from 4M data (material data, facility data, man data, and step data) in manufacturing and quality examination data on the products.

The collector 151 causes the storage unit 14 to store variations in the management parameters and quality of the collected manufactured lots as the aggregated data 141.

When the management parameter or the quality is between an upper limit and a lower limit of a predetermined management width, the collector 151 sets the value of the management parameter or the quality in the aggregated data 141 at “0”.

When the management parameter or the quality is above the upper value and is under a threshold on the upper side, the collector 151 sets the value of the management parameter or the quality in the aggregated data 141 at “+1”.

When the management parameter or the quality is above the threshold on the upper side, the collector 151 sets the value of the management parameter or the quality in the aggregated data 141 at “+2”.

When the management parameter or the quality is above the lower limit and is above a threshold on the lower wide, the collector 151 sets the value of the management parameter or the quality in the aggregated data 141 at “−1”.

When the management parameter or the quality is under the threshold on the lower wide, the collector 151 sets the value of the management parameter or the quality in the aggregated data 141 at “−2”.

The management range of the management parameter of “Time of Stirring” is “32 to 42”, the upper limit is “39”, the lower limit is “37”, the threshold on the upper side is “40”, and the threshold on the lower side is “34” herein. For example, when the management parameter of “Time of Stirring” of a lot is “38”, the collector 151 sets the value of the “Time of Stirring” column in the aggregated data 141 of the lot at “0”. For example, when the management parameter of “Time of Stirring” of a lot is “39”, the collector 151 sets the value of the “stirring time” column in the aggregated data 141 of the lot at “+1”. For example, when the management parameter of “Time of Stirring” of a lot is “33”, the collector 151 sets the value of the “Time of Stirring” column in the aggregated data 141 of the lot at “−2”.

Manufacturing of products of the lot to be evaluated need not be completed. In that case, part of the management parameters and the quality of products in the lot to be evaluated is unknown.

The evaluator 152 evaluates the quality of the lot to be evaluated that is predicted from the management parameters of the lot to be evaluated based on the management parameters and the quality of the manufactured lots.

The display controller 153 causes display of a screen usable for evaluation on the quality of the lot to be evaluated. For example, the display controller 153 causes a display, or the like, to display a screen via the output unit 13.

The display controller 153 causes a display of the screen illustrated in FIG. 3. FIG. 3 is a diagram illustrating an example of the screen. As illustrated in FIG. 3, the display controller 153 arranges, on a matrix, pie charts that correspond to a plurality of management parameters of the manufactured lots, respectively, and that correspond to discrete values representing the degrees of variations with respect to reference values of the management parameters, respectively.

On the horizontal axis of the matrix, the management parameters are aligned in an order (in time order) in which the values are determined in the manufacturing process and the column at the right end corresponds to quality. On the vertical axis, variations in the management parameter or quality are represented by discrete values (at five stages of “−2”, “−1”, “0”, “+1”, “+2”). The values on the vertical axis correspond to the values in the aggregated data 141.

A pie chart represents a proportion of non-defective products in quality and a proportion of defective products in quality in a corresponding lot. The portion surrounded by the solid line in the chart is the proportion of non-defective products in the lot. The portion surrounded by the dashed line in the pie chart is the proportion of defective products in the lot.

For example, about 90% portion of the pie chart corresponding to variation of “−1” in the management parameter of “Material A. Feature 1” is surrounded by the solid line and about 10% portion is surrounded by the dashed line. This means that about 90% of the manufactured lot in which the variation in the management parameter of “Material A. Feature 1” is “−1” is non-defective products in quality and about 10% is defective products in quality.

The line drawn between pie charts represents succession of the management parameter in the lot. A solid line corresponds to a non-defective lot and a dashed line corresponds to a defective lot.

FIG. 3 illustrates that there is a lot in which the management parameter “Material A. Feature 1”, “Time of Stirring”, “Internal Temperature”, “Outlet Temperature”, and “Time of Reaction” make a succession of “+1”, “0”, “0”, “+1”, and “0” and products are non-defective (the quality of “Viscosity” is “0”).

FIG. 3 also illustrates that there is a lot in which the management parameter “Material A. Feature 1”, “Time of Stirring”, “Internal Temperature”, “Outlet Temperature”, and “Time of Reaction” make a succession of “−1”, “0”, “−1”, “0”, and “0” and products are non-defective (the quality of “Viscosity” is “+2”).

Furthermore, the display controller 153 causes a display such that pie charts that are common in degrees of variations with respect to reference values of the management parameters in the lot to be evaluated among the pie charts can be grasped. The display controller 153 presents the lot to be evaluated by solid line. In other words, FIG. 3 illustrates that the management parameters of “Material A. Feature 1”, “Time of Stirring”, “Internal Temperature”, and “Outlet Temperature” of the lot to be evaluated are “+2”, “0”, “−2”, and “0”.

The lot to be evaluated is in the middle of the manufacturing process and the management parameters to “Outlet Temperature” are already set (or known) at the current time but management parameters of and after “Time of Reaction” (including quality) are not set (or unknown).

The display controller 153 receives selection of a pie chart. The display controller 153 displays a histogram, a change trend, a scatter plot, and a process trend with respect to the selected pie chart.

The histogram shows how much the value of the parameter of the selected lot is larger or smaller than the values in the past. The change trend shows the trend of change in the value of the selected parameter, the trend of the state of transition, the relationship with the material lot, etc. The scatter plot shows the relationship between the selected parameters. The process trend makes it possible to check the process trend relative to the selected parameter. This shows through what process the parameter results in.

Comparing with the information on the manufactured lots as in FIG. 3 enables the operator to know the characteristics of the lot to be evaluated. The characteristics of the lot are represented by the patterns (the shape in the solid line) of the management parameters and quality and the degree of variation (the vertical axis).

Even when many management parameters vary, each management parameter does not vary independently. Because of variation in a management parameter, other management patterns are affected in some cases.

For example, when a pie chart is selected in FIG. 3, the display controller 153 displays only the line passing through the pie chart. This narrows the lots to be displayed and enables comparison with the lot to be evaluated.

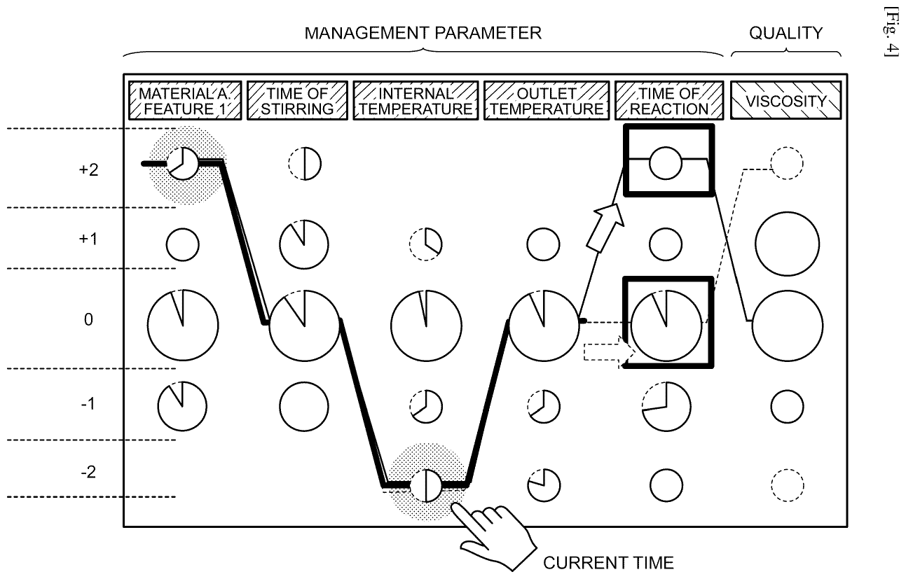

For example, when the graph corresponding to the management parameter of “Material A. Feature 1” and the degree of variation of “+2” is selected, the display controller 153 displays only the lot passing through the pie chart as illustrated in FIG. 4, FIG. 4 is a diagram illustrating an example of the screen.

This shows that, for example, when the variation in the management parameter of “Material A. Feature 1” is wide, the variation in the management parameter of “Internal Temperature” is narrow.

The evaluator 152 selects a lot whose characteristics of the management parameter are similar to the characteristics of the management parameter of the lot to be evaluated from the manufactured lots and, based on the quality of the selected lot, evaluates the quality of the lot to be evaluated.

In the example in FIG. 4, the pie chart corresponding to the management parameter of “Internal Temperature” and the magnitude of variation of “−2” is selected.

The evaluator 152 selects, as lots similar to the lot to be evaluated, a lot whose management parameters from “Material A. Feature 1” to “Outlet Temperature” are common with the lot to be evaluated and whose management parameter of “Time of Reaction” is “+2” and the lot whose management parameter of “Time of Reaction” is “0”.

The lot whose management parameter of “Time of Reaction” is “+2” is a non-defective lot. The lot whose management parameter of “Time of Reaction” is “0” is a defective lot. The lots whose quality of “Viscosity” is “−1”, “0”, “+1” are non-defective lots. The lot whose quality of “Viscosity” is “−2” or “+2” is a defective lot.

When the selected lots include a defective lot, the evaluator 152 makes an evaluation result of “Caution Needed”. When the selected lots include no defective lot, the evaluator 152 makes an evaluation result of “Good”. The evaluator 152 outputs “Caution Needed” or “Good” are the evaluation result.

As described above, the evaluator 152 extracts the pattern of variation and the degree of variation with respect to the reference value as the characteristics of each management parameter and evaluates the quality of the lot to be evaluated using the extracted characteristics.

The operator is able to take action in response to reception of an evaluation result. For example, when the evaluation result is “Good”, the operator continues the current operation. This increases the possibility that non-defective products are obtained in the lot to be evaluated.

For example, when the evaluation result is “Caution Needed”, it is considered that the operator will find the difference between non-defective products and defective products and make an operation to obtain non-defective products. When the lot to be evaluated is during the operation, the operator executes handling during the operation. When the lot to be evaluated is after the operation, the operator executes handling for the following lot.

For example, as illustrated in FIG. 4, the operator is able to increase the possibility that non-defective products be obtained by performing an operation on the lot to be evaluated such that the magnitude of variation in the management parameter of “Reaction Time” is “0”.

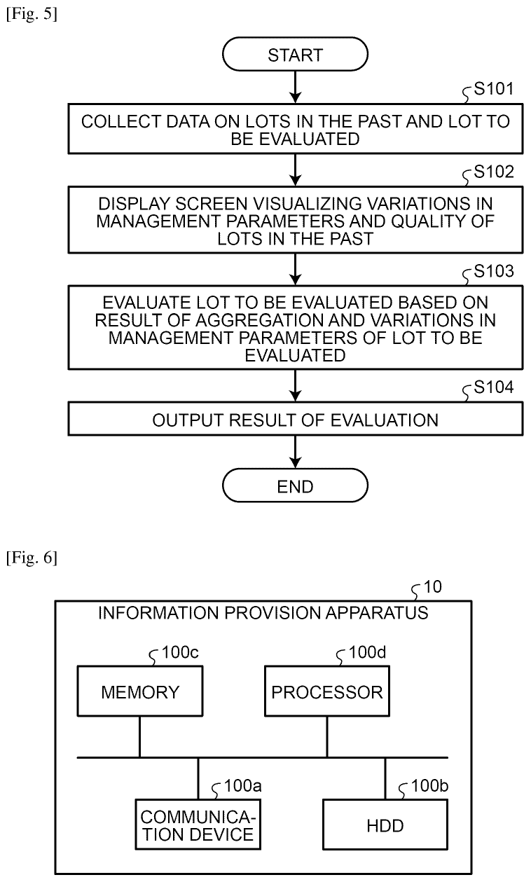

Using FIG. 5, a flow of the process performed by the information provision apparatus 10 will be described. FIG. 5 is a flowchart illustrating the flow of the process performed by the information provision apparatus according to the first embodiment.

As illustrated in FIG. 5, first of all, the information provision apparatus 10 collects data on lots in the past (manufactured lots) and a lot to be evaluated (step S101).

The information provision apparatus 10 causes a display of a screen visualizing variations in management parameters and quality of the lots in the past (step S102).

The information provision apparatus 10 causes a display of the screen in which pie charts are arranged as illustrated in FIG. 3 and FIG. 4.

Subsequently, the information provision apparatus 10 evaluates the lot to be evaluated based on a result of aggregation and variations in the management parameters of the lots in the past and the variations in the management parameters of the lot to be evaluated (step S103) and output the result of the evaluation (step S104).

For example, the information provision apparatus 10 selects lots similar to the lot to be evaluated from the lots in the past. The information provision apparatus 10 is able to calculate a similarity between the lots using the magnitudes of variations in the management parameters. The information provision apparatus 10 evaluates the lot to be evaluated based on whether the selected lots includes a lot in which the manufactured products are defective products.

### Effect

As described above, the information provision apparatus 10 includes the collector 151 and the evaluator 152. The collector 151 collects management parameters and quality of manufactured lots. The evaluator 152 evaluates quality of a lot to be evaluated that is predicted from management parameters of the lot to be evaluated based on the management parameters and the quality of the manufactured lots.

The information provision apparatus 10 evaluates the lot to be evaluated based on the manufactured lots in the past. This enables an operator to stably achieve a quality target by referring to the result of the evaluation made by the information provision apparatus 10.

Defective products are manufactured in some cases even if the operator sets the management parameters within management ranges. The information provision apparatus 10 is able to inhibit the operator from having such an experience and increase motivation of the operator.

The information provision apparatus 10 makes it possible to avoid unproductiveness in producing defective products actually in advance to some extent. There is a risk that defective products are shipped if examination on the products is sampling inspection; however, the information provision apparatus 10 makes it possible to reduce the risk.

The evaluator 152 extracts patterns of variations and degrees of variations with respect to reference values as characteristics of the respective management parameters and evaluates the quality of the lot to be evaluated using the extracted characteristics. The evaluator 152 selects a lot whose characteristics of the management parameters are similar to characteristics of the management parameters of the lot to be evaluated from the manufactured lots and evaluates the quality of the lot to be evaluated based on quality of the selected lot.

Thus, the information provision apparatus 10 is able to evaluate the lot to be evaluated with reference to the lots in the past similar in variations in the management parameters and present appropriate management parameters.

The display controller 153 causes a display in which pie charts that correspond to the management parameters of the manufactured lots, respectively, that correspond to discrete values representing degrees of variations with respect to reference values of the management parameters, respectively, and that represent a proportion of non-defective products in quality and a proportion of defective products in quality in a corresponding lot are arranged on a matrix and further causes a display such that pie charts that are common in degrees of variations with respect to the reference values of the management parameters in the lot to be evaluated among the pie charts can be grasped. This enables the operator to instinctively compare the characteristics of the lot to be evaluated and the characteristics of the manufactured lots in the past.

### System

The process procedure, control procedure, specific names, and information including various types of data and parameters that are presented in the description above and the drawings are changeable freely unless otherwise noted.

Each component of each device illustrated in the drawings is a functional idea and need not necessarily be configured physically as illustrated in the drawings. In other words, specific modes of distribution and integration of devices are not limited to those illustrated in the drawings. In other words, all or part of the devices can be configured by functional or physical distribution or integration in any unit according to various types of load and usage.

Furthermore, all or given part of each processing function implemented by each device can be realized by a CPU and a program that is analyzed and executed by the CPU or can be realized as hardware according to a wired logic.

### Hardware

An example of a hardware configuration of the information provision apparatus 10 will be described next. FIG. 6 is a diagram illustrating the example of the hardware configuration. As illustrated in FIG. 6 the information provision apparatus 10 includes a communication device 100a, a HDD (Hard Disk Drive) 100b, a memory 100c, and a processor 100d. The units illustrated in FIG. 6 are connected mutually by a bus, or the like.

The communication device 100a is a network interface card, or the like, and communicates with another server. The HDD 100b stores a program that causes the functions illustrated in FIG. 1 to be on and a DB.

The processor 100d reads the program that executes the same process as that of each of the processors illustrated in FIG. 1 from the HDD 100b, or the like, and loads the program in the memory 100c, thereby running the process that implements each of the functions illustrated in FIG. 4, etc. For example, the process implements the same function as that of each of the processors that the information provision apparatus 10 includes. Specifically, the processor 100d reads the program with the same functions as those of the collector 151, the evaluator 152, and the display controller 153 from the HDD 100b, or the like. The processor 100d then executes the process of executing the same processes as those performed by the collector 151, the evaluator 152, and the display controller 153.

As described above, the information provision apparatus 10 operates as an information provision apparatus that reads and executes a program, thereby executing the information provision method. The information provision apparatus 10 reads the above-described program from a recording medium using a medium reading device and execute the read program, thereby enabling implementation of the same functions as those of the above-described embodiment. Other programs according to the embodiment are not limited to being executed by the information provision apparatus 10. For example, the present invention can be similarly applicable to the case where another computer or another server executes the program or the computer and the server execute the program cooperatively.

The program can be distributed via a network, such as the Internet. The program can be recorded in a computer-readable recording medium, such as a hard disk, a flexible disk (FD), a CD-ROM, a MO (Magneto-Optical disk), or a DVD (Digital Versatile Disc), can be read by a computer from the recording medium, and thus can be executed.

### REFERENCE SIGNS LIST

10 information provision apparatus
11 communication unit
12 input unit
13 output unit
14 storage unit
15 controller
141 aggregated data
151 collector
152 evaluator
153 display controller

1. An information provision apparatus comprising:
a processor configured to:
collect management parameters and quality of manufactured lots; and
evaluate quality of a lot to be evaluated that is predicted from management parameters of the lot to be evaluated based on the management parameters and the quality of the manufactured lots.

2. The information provision apparatus according to claim 1, wherein the processor is configured to select a lot whose characteristics of the management parameters are similar to characteristics of the management parameters of the lot to be evaluated from the manufactured lots and evaluate the quality of the lot to be evaluated based on quality of the selected lot.

3. The information provision apparatus according to claim 2, wherein the processor is configured to extract patterns of variations and degrees of variations with respect to reference values as characteristics of the respective management parameters and evaluate the quality of the lot to be evaluated using the extracted characteristics.

4. The information provision apparatus according to claim 1, wherein the processor is configured to cause a display in which pie charts that correspond to the management parameters of the manufactured lots, respectively, that correspond to discrete values representing degrees of variations with respect to reference values of the management parameters, respectively, and that represent a proportion of non-defective products in quality and a proportion of defective products in quality in a corresponding lot are arranged on a matrix and cause a display such that pie charts that are common in degrees of variations with respect to the reference values of the management parameters in the lot to be evaluated among the pie charts can be grasped.

5. An information provision method that is executed by a computer, the method comprising:
collecting management parameters and quality of manufactured lots; and
evaluating quality of a lot to be evaluated that is predicted from management parameters of the lot to be evaluated based on the management parameters and the quality of the manufactured lots.

6. A non-transitory computer-readable recording medium having stored therein a program that causes a computer to execute a process comprising:
collecting management parameters and quality of manufactured lots; and
evaluating quality of a lot to be evaluated that is predicted from management parameters of the lot to be evaluated based on the management parameters and the quality of the manufactured lots.
